(19) United States
(12) Patent Application Publication
(10) Pub. No.: US 2004/0078797 A1
(43) Pub. Date: Apr. 22, 2004

(54) Method for arranging object event timing on a web page

(76) Inventor: Hsin-Chi Liao, Taipei (TW)

Correspondence Address: LAW OFFICES OF CLEMENT CHENG, 17220 NEWHOPE STREET #127, FOUNTAIN VALLEY, CA, 92708, US

(21) Appl. No.: 10/263,437

(22) Filed: Oct. 3, 2002

(51) Int. Cl. G06F 9/54

(52) U.S. Cl. 719/310

(57) ABSTRACT

A method for arranging object event timing on a web page, first planning an event-triggering schedule of objects on a web page; the event-triggering schedule is used to trigger each of object's events at each presetting time point. The foregoing objects can be the type of graph, video, and audio, Next, setting particular action for object's event when they are triggered. Finally, activate a timer to sequentially trigger the object's event at each corresponding time point according to the event-triggering schedule.

### BACKGROUND OF THE INVENTION

1. Field of the Invention

This invention generally relates to the field of web technique. More particularly, the present invention relates to a method for arranging objects event timing on a web page.

2. Description of the Prior Art

The present day, there are many assistant education software to be used to record the cursor motion on the computer screen, or used to edit content of courses. Besides, the content of courses can be repeatedly used for the purpose of education or demonstration. Therefore, it provides a new kind of learning method for general users through this way.

However, the foregoing capability is permitted only by using specified software when users want to view or play the recorded content, therefore it causes restriction on users.

Due to the generality of Internet application, Internet already becomes a convenient and rapid approach for searching or learning. Besides, general users use web browser to access Internet and then don't have to install specified software tool. Therefore, it's necessary for user to view moving photograph or cursor motion through web browser.

### SUMMARY OF THE INVENTION

According to the shortcoming mentioned in the background, the present invention provides a method for arranging object event timing on a web page.

Accordingly, one object of the present invention is to replay the motion of arranged photograph.

Another object of the present invention is to control the objects contained on web page, and to trigger the object event based on schedule.

According to foregoing objects mentioned above, the present invention provides a method for arranging object event timing on a web page, first planning an event-triggering schedule of objects on a web page; the event-triggering schedule is used to trigger each of object's events at each presetting time point. The foregoing objects can be the type of photograph, video, and audio, a timer may embedded in a web page with said objects after the timer completing scheduling, or the timer will be download to user side in advance.

Next, setting particular event to each of corresponding objects for when they are triggered. Finally, activate a timer to sequentially trigger the object's event at each corresponding time point according to the event-triggering schedule.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 is the first preferred embodiment of the present invention;

FIG. 2 is the second preferred embodiment of the present invention; and

FIG. 3 illustrates the flow chart of the method for arranging object event timing on a web page of the present invention.

### DESCRIPTION OF THE PREFERRED EMBODIMENT

Some sample embodiments of the invention will now be described in greater detail. Nevertheless, it should be noted that the present invention can be practiced in a wide range of other embodiments besides those explicitly described, and the scope of the present invention is expressly not limited except as specified in the accompanying claims.

The present invention provides a method for arranging object event timing on a web page, the steps of the method comprising: planning a event-triggering schedule of a timer, the event-triggering schedule is used to trigger a object's event at each of pre-setting time point; next, setting the object's event for when the object is triggered, and the object is embedded in a web page which requested by a user; and last activating the timer to trigger said object at pre-setting time point according to the event-triggering schedule.

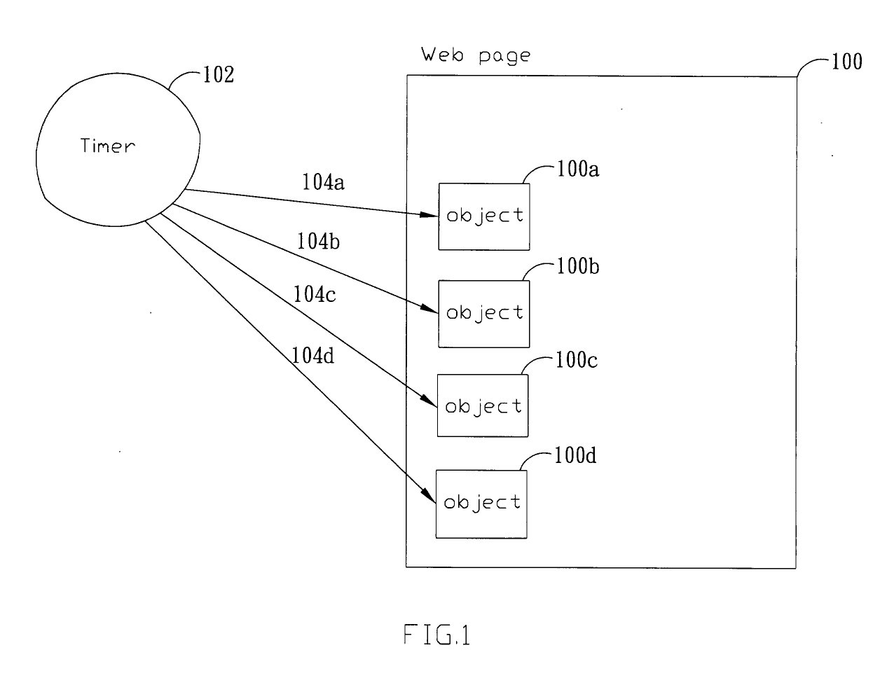

FIG. 1 illustrates the first preferred embodiment of the present invention, wherein the web page 100 comprises first object 100a, second object 100b, third object 100c, and fourth object 100d. These objects has data types that may be used to embed in a web page. For instance, the data type can be graph, video, and audio, but not limited to the foregoing data types. In this first preferred embodiment, the first object 100a, second object 100b, third object 100c, and fourth object 100d are serial graphs used to depict continuing movement of a cursor. However, the objects included in the same web page 100 can have different data types, not necessarily have the same data type.

When user downloads the web page 100 to a computer, the first object 100a, second object 100b, third object 100c, and fourth object 100d are downloaded contemporaneously with the web page 100 due to these object are embedded inside the web page 100. The timer 102 is a kind of clock, and used to sequentially trigger objects according to pre-setting time. Furthermore, the timer 102 is either embedded in the web page 100 and downloaded to user's computer, or the timer 102 is embedded in other web page, and then downloaded to user's computer in advance.

As shown in FIG. 1, the first object 100a, second object 100b, third object 100c, and fourth object 100d are cursor graphs embedded in the web page 100, the positions of the cursor graphs in the web page 100 are pre-defined, and the visibility attributes of these cursor graphs are hidden. That means when the web page 100 is displayed by user's web browser, user can't see these cursor photographs on the web page 100 due to the hidden value of the visibility attribute.

The timer 102 sends notification to trigger object's event at different time point according to an event-triggering schedule that planned in advance. In this first preferred embodiment, the timer 102 will respectively send the notification 104a, 104b, 104c, and 104d at different time point to trigger the events of the first object 100a, second object 100b, third object 100c, and fourth object 100d according to an event-triggering schedule that planned in advance. In this preferred embodiment, the notification 104a firstly triggers the first object 100a to change the visibility attribute of the first object 100a from hidden to visible; accordingly in the meanwhile user can see the first object 100a is shown. Subsequently, user can further see the triggered objects 100b˜100d sequentially displayed on the web page 100, thus make user see a continuous cursor motion formed by the graph objects 100a˜100d.

Therefore, through planning the event-triggering schedule of timer 102 and the positions of the photographs in advance, user can view an edited cursor motion upon a web page.

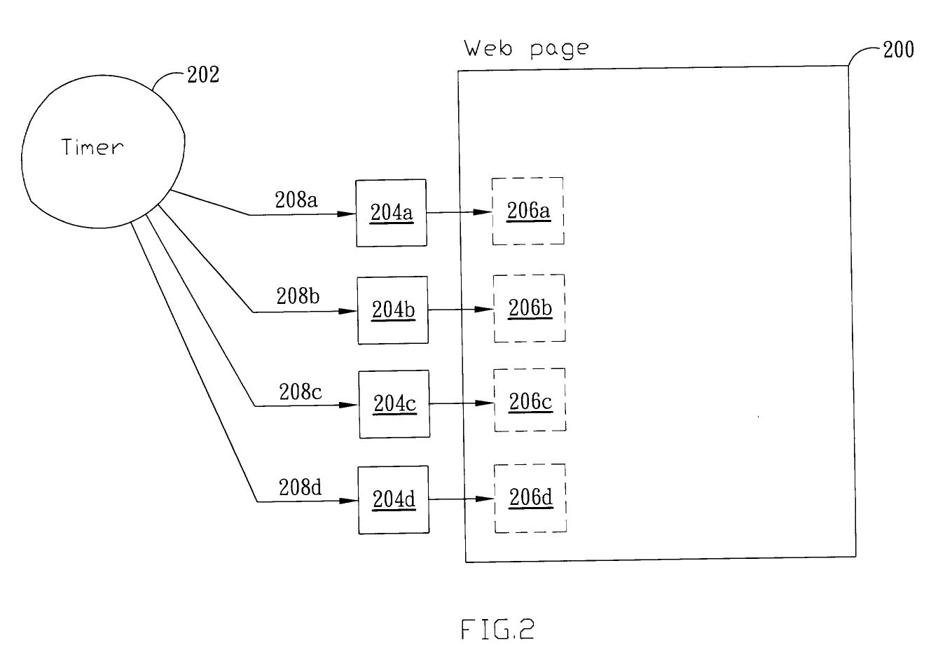

FIG. 2 illustrates the second preferred embodiment of the present invention, wherein the web page 200 is requested and viewed by user, the data type of the object 204a object 204d are photograph type, but not limited in photograph type. In other embodiment, the objects can be the data type of video or audio type. In this second preferred embodiment, the first object 204a, second object 204b, third object 204c, and fourth object 204d are serial photographs used to form a continuous cursor motion, but the objects are not embedded in the web page 200 in advance. However, the objects included in web page 200 can be various data types, not limited in the same data types.

When user requests the web page 200, the photograph object 204a˜204d are downloaded to user's computer with the web page 200. The timer 202 is a kind of clock, and used to sequentially trigger objects according to pre-setting time points. Furthermore, the timer 102 is embedded in the web page 200 and downloaded to user's computer, or the timer 202 is embedded in other web page, and then downloaded to user's computer in advance.

As shown in FIG. 2, the first object 204a, second object 204b, third object 204c, and fourth object 204d are cursor photographs, these cursor photographs are not embedded in the web page 200. That mean user can't see these cursor photographs on the web page 200 when the web page 200 is displayed.

The timer 202 sends notification to trigger object's event at different time point according to an event-triggering schedule that planned in advance. In this second preferred embodiment, the timer 202 will respectively send the notification 208a, 208b, 208c, and 208d at different time point to trigger the events of the first object 204a, second object 204b, third object 204c, and fourth object 204d according to an event-triggering schedule that planned in advance. In this preferred embodiment, the notification 208a triggers the event of the first cursor graph object 204a; therefore the first object 204a will be inserted to a specified position 206a of the web page 200. In the meanwhile user can see the first object 204a appeared on the web page 200. Subsequently, the remaining objects 204b˜204d will also be inserted to respectively specified position 206b˜206d of the web page 200 through the notification 208b˜208d as shown in FIG. 2. Therefore, user can see the triggered objects 204a˜204d sequentially appear on the web page 200 to form a continuous cursor motion.

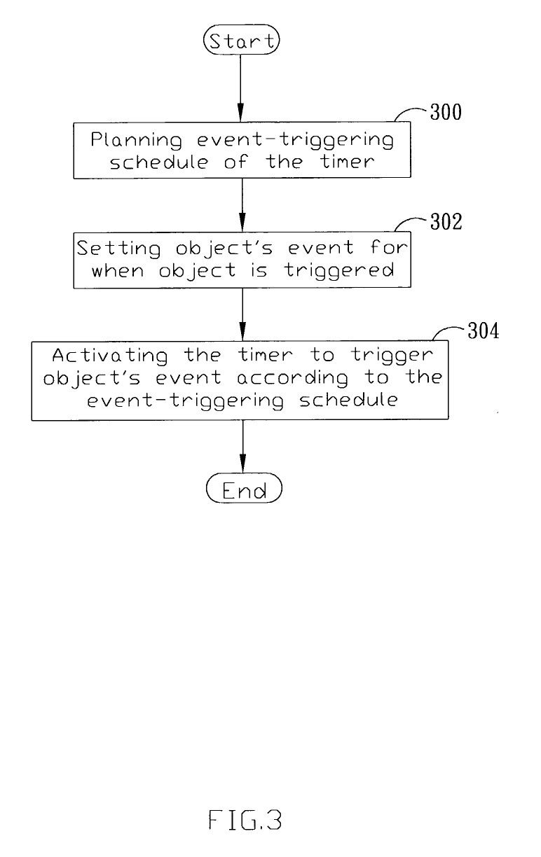

FIG. 3 illustrates the flow chart of the method for arranging object event timing on a web page of the present invention. Firstly, planning an event-triggering schedule of a timer 300, the event-triggering schedule is used to trigger object's event at each pre-setting time point. The timer will either be embedded into the web page with the objects, or be downloaded to user side in advance.

Next, respectively setting the events for when the objects are triggered 302, for example, the data types of the objects are photograph in the foregoing first preferred embodiment, and then the visibility attribute of the objects are changed from hidden to visible when the objects are triggered. Lastly, activating the timer to trigger objects' event at each pre-setting time point based on the event-triggering schedule 304.

Therefore, according to the description mentioned above, the present invention provides a method for arranging object event timing on a web page. User can view meaning motion demonstrated on web page directly through web browser. Furthermore, the present invention can be used to edit object's event at a pre-setting time point by setting a timer and object's event.

Although specific embodiments have been illustrated and described, it will be obvious to those skilled in the art that various modifications may be made without departing from what is intended to be limited solely by the appended claims.

What is claimed is:

1. A method for arranging object event timing on a web page, said method comprising:
planning a event-triggering schedule of a timer, said event-triggering schedule is used to trigger a object's event at each of pre-setting time point;
setting an action for said object's event when said object is triggered, wherein said object is embedded in a web page which is requested by a user; and
activating said timer to trigger said object at the pre-setting time point according to said event-triggering schedule.

2. The method according to claim 1, wherein said timer is embedded in said web page.

3. The method according to claim 1, wherein said timer is embedded in another web page, and said timer is downloaded to said user before said web page.

4. The method according to claim 1, wherein said object is graph.

5. The method according to claim 4, wherein said photograph's visibility attribute is changed from hidden to visible when said photograph is triggered by said timer.

6. A method for arranging object event timing on a web page, said method comprising:
planning a event-triggering schedule of a timer, said event-triggering schedule is used to trigger an object's event at each of pre-setting time point;
setting an action for a event of said object when said object is triggered; and
activating said timer to trigger said object at the pre-setting time point according to said event-triggering schedule.

7. The method according to claim 6, wherein said object has different data type from each other.

8. The method according to claim 6, wherein said object is graph.

9. The method according to claim 8, wherein said photograph is inserted to an assigned position in said web page when said graph is triggered by said timer.

10. The method according to claim 9, wherein said timer is embedded in said web page.

11. The method according to claim 9, wherein said timer is embedded in another web page, and said timer is downloaded to said user side in advance.

12. A method for replaying a cursor motion on a web page, said method comprising:
embedding serial graphs in a web page, wherein said graph is used to replay a cursor motion, and the attributes of said serial graphs are hidden;
planning a event-triggering schedule of a timer, said event-triggering schedule is used to trigger said serial photographs at each pre-setting time point;
activating said timer to trigger said serial graphs at pre-setting time point according to said event-triggering schedule.

13. The method according to claim 12, wherein said timer is embedded in said web page.

14. The method according to claim 12, wherein said timer is embedded in another web page, and said timer is downloaded to said user in advance.
